(19) United States
(12) Patent Application Publication
(10) Pub. No.: US 2003/0198762 A1
(43) Pub. Date: Oct. 23, 2003

(54) Production of preforms from which bottles can be blown

(75) Inventor: Pieter Wouter Du Toit, Northern Paarl (ZA)

Correspondence Address: Ladas & Parry, 26 West 61st Street, New YorK, NY, 10023, US

(73) Assignee: LOMOLD CORPORATION NV

(21) Appl. No.: 10/418,350

(22) Filed: Apr. 18, 2003

(30) Foreign Application Priority Data
Apr. 23, 2002 (GB) 0209186.6

(51) Int. Cl. B32B 1/02

(52) U.S. Cl. 428/34.1; 264/319; 264/523; 264/532; 425/524; 425/414

(57) ABSTRACT

A method of, and an apparatus for, producing preforms from which bottles can be blown, are disclosed. The method includes using a piston (72) to force mouldable material (M) into a preform shaped cavity (52). The mouldable material enters via a feed pipe (68) and a valve (70). The cavity (52) is bounded by a female mould part (48) and by a male mould part (50) comprising a sleeve (56) and rod (58) with a head (60) at one end. The piston (72), as it advances, pushes the material (M) into the mould cavity (52). A blow mould cavity (54) receives the moulded preform and the core (50) so that the preform can be blown without being removed from the core.

### FIELD OF THE INVENTION

THIS INVENTION relates to the production of preforms from which bottles can be blown.

### BACKGROUND TO THE INVENTION

Preforms are manufactured as a first step in the production of certain types of blow moulded bottles. Conventionally preforms are injection moulded in a die comprising a female member and a male member. The male member is in the form of an elongate core. The moulded preform has a cylindrical wall bounding an elongate interior cavity. At one end there is the structure, such as threading and encircling flanges, which become the mouth region of the blown bottle. The preform is open at this end and closed at the other end by a hemispherical dome. The injection point for the synthetic plastics material is at the centre of the dome i.e. at its pole.

A major difficulty in the production of preforms by injection moulding is the sprue mark which exists at the injection gate. This can cause a weakened zone which is of particular concern if the bottle is to contain a carbonated drink and is hence under internal pressure. Even when the bottle contains non-carbonated liquid, the weakened zone is a cause for concern as the bottle can break at this weakened zone if dropped.

Furthermore freezing of material at the gate results in a protruding piece of material remaining on the preform. This has to be broken off and the resultant jagged end detracts from the aesthetics of the bottle.

If the preform is being moulded in the material known as PET, then acetaldehyde is produced particularly in the highly stressed area around the sprue mark. Acetaldehyde is known to impart a faint odour to the product in the bottle.

One object of the present invention is to provide a method of manufacturing a preform which avoids the problems associated with an injection point at the pole of the dome-shaped end of the preform and also a further object of the invention is to provide an apparatus for this purpose.

Another object of the present invention is to provide improved methods of manufacturing blow moulded bottles.

### BRIEF DESCRIPTION OF THE INVENTION

According to one aspect of the present invention there is provided apparatus for manufacturing a preform which includes a mould comprising a female die member and a male die member in the form of an elongate core which together define between them a mould cavity having the shape of said preform, a barrel which communicates with said cavity, means for feeding mouldable material into said barrel, a piston, and means for advancing said piston along said barrel so that the front face thereof displaces mouldable material out of said barrel and into said cavity, the front face of said piston, when said piston is fully advanced, becoming part of said bounding wall of said cavity.

In one form said barrel communicates with said cavity on the side thereof opposite to the core and the front face of said piston is of concave generally hemispherical form. In another form said barrel can be constituted by a passageway in said core and said front face can be of generally hemispherical convex form. In a still further form said barrel is constituted by a cylindrical extension of said cavity and said front face is the annular front face of a tubular piston.

The apparatus can further include a blow moulding cavity and means for transferring said core with a moulded preform on it from said female die member to said blow moulding cavity.

Said core can include first and second parts which can be displaced relatively to one another to increase and decrease the length of said core.

According to a further aspect of the present invention there is provided a method of manufacturing a preform which method includes the steps of closing a mould comprising a male member and a female member which together define a mould cavity that has the shape of said preform, feeding mouldable material into a barrel the bore of which communicates with said cavity, and advancing a piston along said barrel so that said piston urges said material out of said barrel and into said cavity, said piston having a concave front face which, in the fully advanced position of the piston, completes said mould cavity and constitutes that part of the bounding wall of said cavity which moulds the outer face of the dome-shaped end surface of said preform.

According to a still further aspect of the present invention there is provided apparatus for manufacturing a preform which apparatus comprises a mould comprising a male member and a female member which together partly define a mould cavity that has the shape of said preform, a barrel, means for feeding mouldable material into said barrel the bore of which communicates with said cavity, a piston and means for advancing said piston along said barrel so that said piston urges said material out of said barrel and into said cavity, said piston having a concave front face which, in the fully advanced position of said piston, completes said mould cavity and constitutes that part of the bounding wall of said cavity which moulds the outer face of the dome-shaped end surface of said preform.

According to another aspect of the present invention there is provided a method of manufacturing a preform which method comprises closing a mould including a female member and a core constituting a male member which together define a mould cavity having the shape of said preform, feeding mouldable material into a cylindrical extension of said mould cavity which extension is bounded internally by said male member and externally by said female member; and advancing a tubular piston along said extension to force said material out of said extension and into said cavity, the annular leading face of said piston, once it is fully advanced, becoming part of the bounding wall of said cavity.

The method can further include the step of withdrawing the moulded preform and said core from said female member, inserting said preform and core into a blow moulding cavity and feeding air along a passage in said core to expand said preform into said blow moulding cavity. Said method can include the further step of stretching the preform during blowing by extending said core.

According to yet another aspect of the present invention there is provided apparatus for manufacturing a preform which apparatus comprises a mould including a female member and a core constituting a male member which together define a mould cavity having the shape of said preform, means for feeding mouldable material into a cylindrical extension of said mould cavity which extension is bounded internally by said male member and externally by said female member; a tubular piston and means for advancing said piston along said extension to force said material out of said extension and into said cavity, the annular leading face of said piston, once it is fully advanced, becoming part of the bounding wall of said cavity.

According to a still further aspect of the present invention there is provided a method of moulding a preform which method includes the steps of closing a mould comprising a female member and a core constituting a male member which together define a mould cavity having the shape of said preform, feeding mouldable material into a barrel constituted by a bore extending along said core which bore communicates with said cavity, and advancing a piston in said barrel so that the front face thereof forces said material out of said barrel and into said cavity, said front face being dome-shaped and, when said piston is fully advanced, becoming that part of the bounding wall of said mould cavity which defines the inner surface of the dome-shaped end of said preform.

The method defined in the preceding paragraph can further include the step of withdrawing the moulded preform and said core from said female member, inserting said preform and core into a blow moulding cavity and feeding air along a passage in said core to expand said preform into said blow moulding cavity. Said method can include the further step of stretching said preform before blowing by extending said core.

According to yet another aspect of the present invention there is provided apparatus for moulding a preform which apparatus includes a mould comprising a female member and a core constituting a male member which together define a mould cavity having the shape of said preform, a barrel, means for feeding mouldable material into said barrel, said barrel being constituted by a bore extending along said core and which communicates with said cavity, a piston in said barrel, and means for advancing said piston in said barrel so that the front face thereof forces said material out of said barrel and into said cavity, said front face of said piston being dome-shaped and, when said piston is fully advanced, becomes that part of the bounding wall of said mould cavity which defines the inner surface of the dome-shaped end of said preform.

According to yet a further aspect of the present invention there is provided a preform from which a bottle can be blown, and which preform is of hollow cylindrical form, said preform being open at one end and closed at the other by a dome-shaped end wall, there being at the other end thereof external formations which form the means for attaching a closure to the bottle once blown, the dome-shaped external end surface of said preform being devoid of an injection point stress zone.

### BRIEF DESCRIPTION OF THE DRAWINGS

For a better understanding of the present invention, and to show how the same may be carried into effect, reference will now be made, by way of example, to the accompanying drawings in which:

FIGS. 1 and 2 illustrate the two stages of a method of manufacturing a preform;

FIGS. 3 to 7 illustrate the stages of a further method of manufacturing a preform; and

FIGS. 8 to 12 illustrate the stages of a still further method of manufacturing a preform.

### DETAILED DESCRIPTION OF THE DRAWINGS

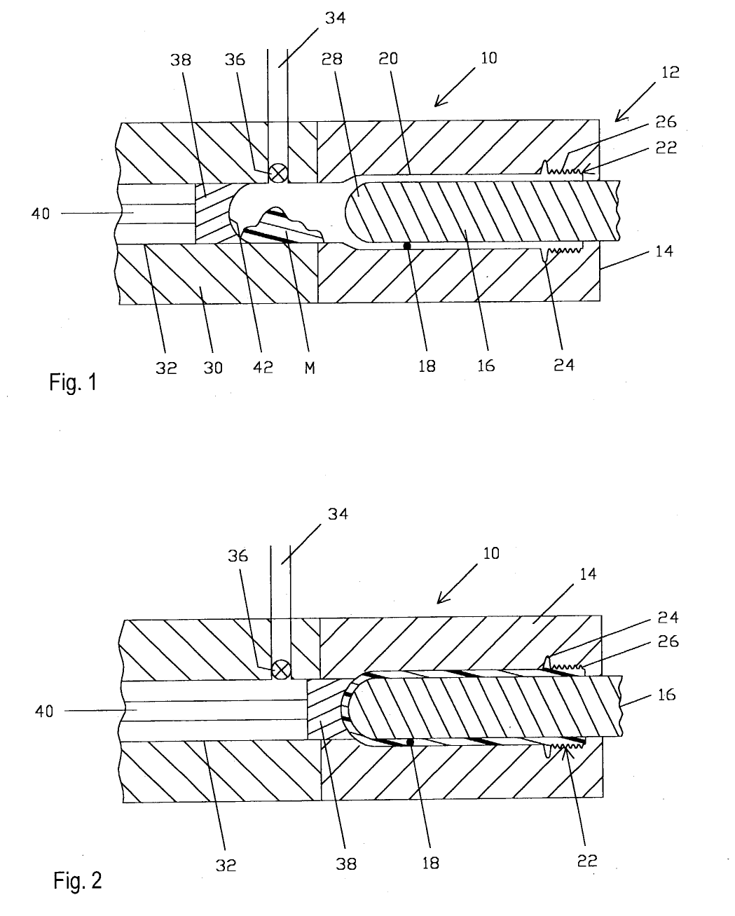

Referring firstly to FIGS. 1 and 2, the apparatus illustrated is generally designated 10 and comprises a mould 12 including a female die part 14 and a male die part 16 which is in the form of an elongate core. The parts 14 and 16 define between them a cavity designated 18 which has the shape of the preform to be moulded. More specifically, the cavity has a cylindrical section 20 at one end of which there are formations 22 which mould the part of the preform which becomes the neck of the blown bottle. In the illustrated form the formations 22 comprise an encircling flange 24 and threading 26. The other end of the cavity is bounded internally by the hemispherical end 28 of the part 16.

The mould 12 further includes a block 30 which defines a barrel 32. The barrel 32 opens into the cavity 18. Means are provided for delivering a measured charge of mouldable material, designated M in the drawing, to the barrel 32. Such means can be a feed screw in a feed path 34. There is a valve 36 between the feed path 34 and the barrel 32.

A piston 38 is provided in the barrel 32. A rod 40 extends away from the piston 38 and constitutes means for displacing the piston in advancing and retracting movements along the barrel 32.

The front face of the piston is in the form of a concave substantially hemispherical surface 42.

Once the mould has been closed and material M has been fed into the barrel 32, the piston 38 is advanced from the position shown in FIG. 1 to the position shown in FIG. 2. Mouldable material is thus urged by the front face of the piston out of the barrel 32 and into the cavity 18 which it fills entirely. The hemispherical front face 42 of the piston 38 becomes, as seen in FIG. 2, part of the bounding wall of the cavity. More specifically, it defines that part of the bounding wall which moulds the dome-shaped generally hemispherical end of the preform or defines part of this end.

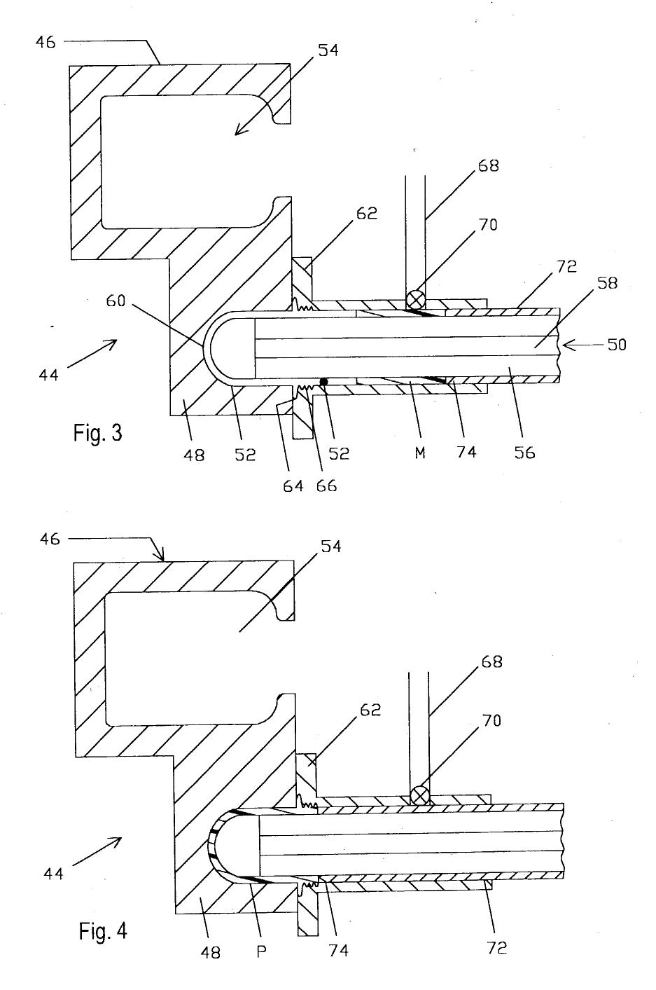

Turning now to FIGS. 3 to 7, the apparatus illustrated is generally designated 44 and comprises a split mould structure which is generally designated 46. The mould structure provides a female mould part 48 which, together with a male mould part in the form of a core 50, defines a cavity 52 having the shape of the preform to be moulded. The mould structure 46 also provides a blow moulding cavity 54.

The core 50 comprises a tubular sleeve 56 and a rod 58 which slides in an axial bore of the sleeve 56. At one end the rod has a head 60 the surface of which is generally hemispherical. The female part of the die structure includes a further component designated 62. The component 62 is in two parts and there is a split line (not shown) between them. The component 62 bounds that part of the preform which eventually becomes the neck of the blown bottle. More specifically, in FIG. 3, the component 62 defines an encircling flange 64 and threading 66.

Reference numeral 68 designates a feed path which leads to the cavity 52 between the component 62 and the core 50. There is a valve 70 where the feed path 68 enters the cavity 52.

In this form of the apparatus there is a piston, designated 72, which is tubular in form and has an annular front face designated 74. Means (not shown) are provided for reciprocating the piston 72.

With the piston 72 retracted to the position shown in FIG. 3, material M to be moulded is fed in through the feed path 68 and valve 70. The quantity of material fed in is predetermined so that it is sufficient to fill the cavity 52 which constitutes the barrel of the apparatus. The valve 70 is then closed.

The piston 72 advances from the position shown in FIG. 3 to the position shown in FIG. 4. The material is thus forced from the cylindrical space between the core 50 and the component 62 into the mould cavity 52 which has the shape of the preform. It will be seen from FIG. 4 that the face 74 of the piston becomes part of the bounding wall of the mould cavity and defines that surface of the preform which eventually becomes the annular top surface which encircles the mouth of the blow moulded bottle.

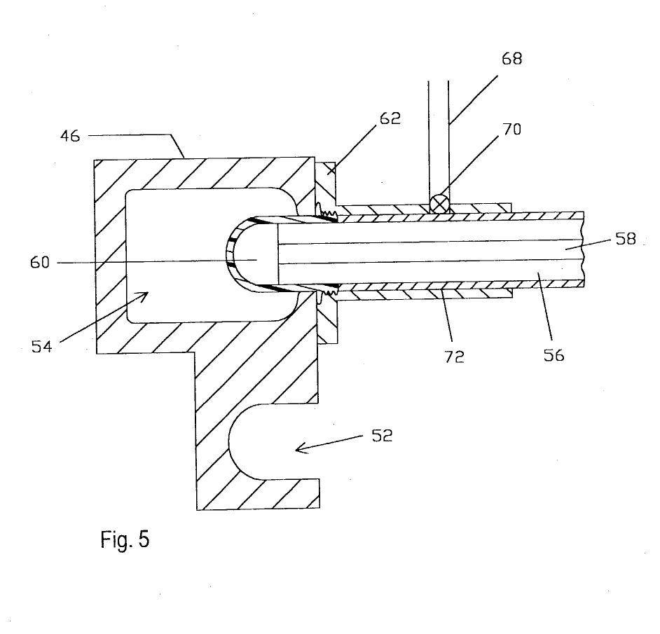

The moulded preform, designated P, with the core 50 still inside it, is transferred from the cavity 52 to the cavity 54. This is preferably achieved by retracting the core 50, component 62 and piston 72 to the right, indexing the mould structure 46 to a succeeding position so that the moulded preform is aligned with the cavity 54, and then advancing the structure to the left to insert the preform into the cavity 54 as shown in FIG. 5.

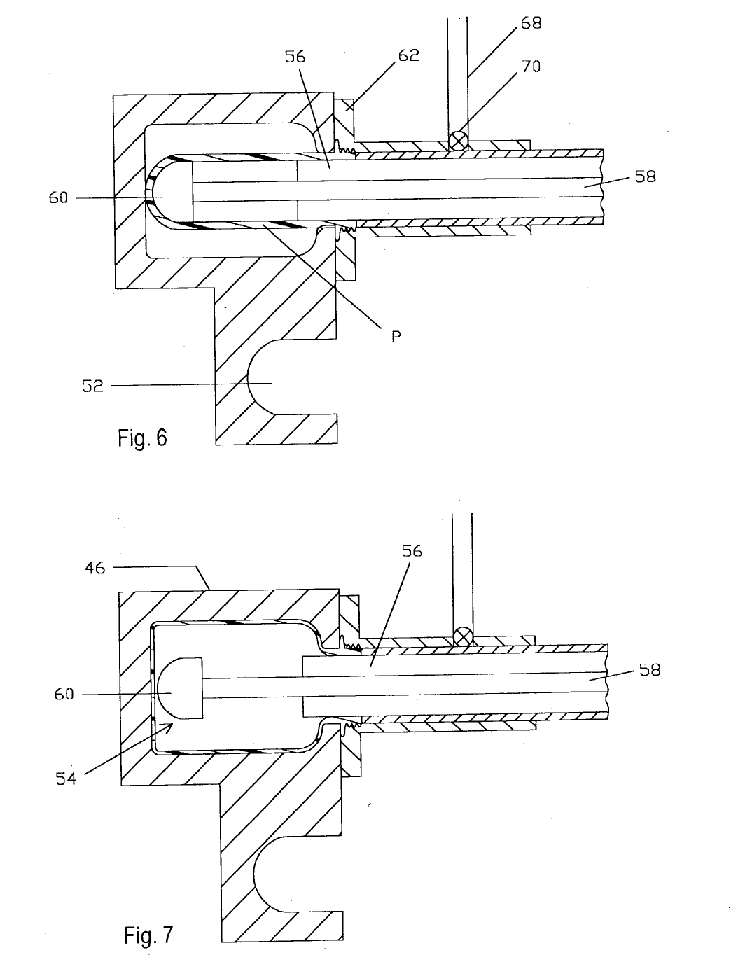

The preform can be heated or cooled so that it attains the correct temperature prior to its insertion into the-cavity 54 and then stretched by advancing the rod 58 and head 60 to the left (see FIG. 6). Air is fed along passages (not shown) in the sleeve 56 to expand the preform into the shape of the blow moulding cavity as best seen in FIG. 7. The halves of the mould 46 and the halves of the component 62 are separated to eject the blown bottle.

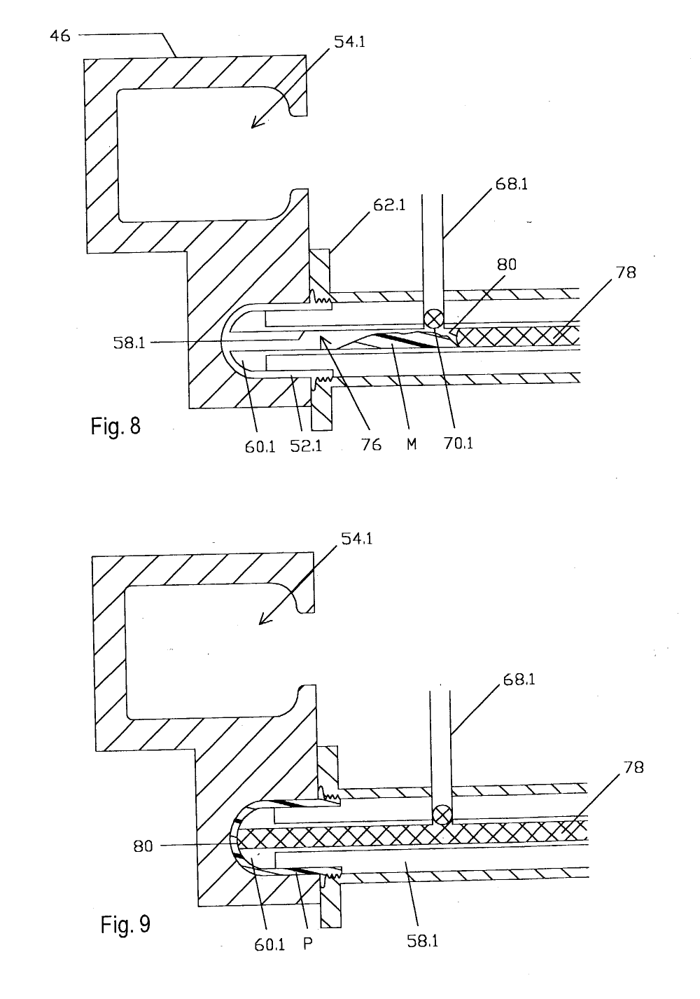

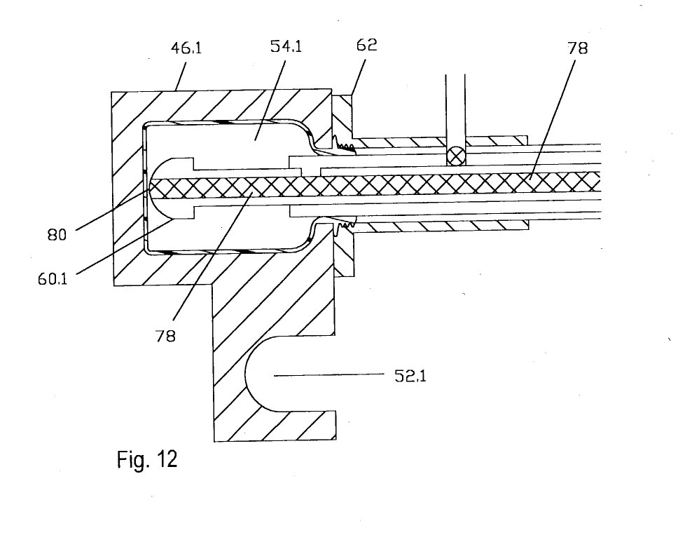

The apparatus of FIGS. 8 to 12 has features in common with the apparatus of FIGS. 3 to 7. As a consequence, like components have been designated with like reference numerals to which the suffix 0.1 has been added.

In the embodiment of FIGS. 8 to 12, the rod 58.1 and the head 60.1 have a passageway 76 therethrough. Material is fed into this passageway rather than into the cylindrical extension of the mould cavity 52 as in FIGS. 3 to 7. The passageway 76 opens through the head 60.1 into the cavity 52.1.

Within the passageway 76 there is a piston 78. The front face of the piston 78, which face is designated 80, is in the form of a hemisphere or of part of a hemisphere.

Once a charge of material M of predetermined volume has been fed into the passageway 76, the piston 78 is advanced so that its front face 80 urges the material M out of the passageway 76 and into the mould cavity 52.1. This is shown in FIG. 9 and it will be seen that the front face 80 and the face of the head 60.1 together form a hemisphere against which the internal hemispherical, dome-shaped end of the preform is moulded.

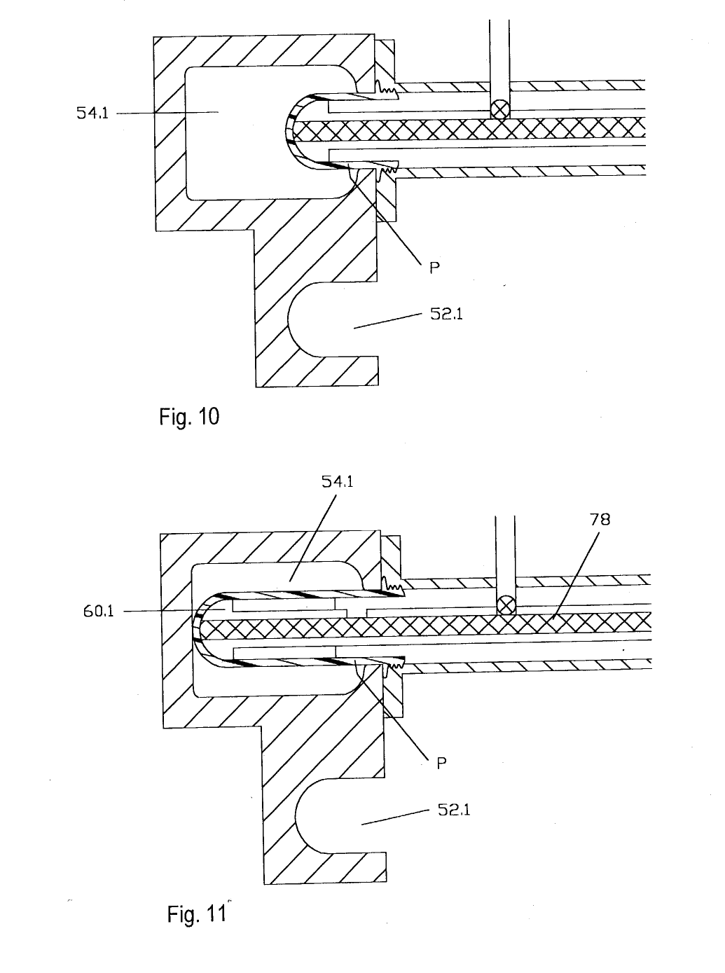

The steps which are taken subsequently to stretch and blow the preform are illustrated in FIGS. 10, 11 and 12 and the sequence is the same as that illustrated in FIGS. 5 to 7. The stretching operation can be performed by moving the head 60.1 and the piston 78 in unison as illustrated, or by moving only the piston 78.

Applicant believes that moulding preforms using pistons as described above has the advantage that, as the plastics material is less stressed, the formation of aldehyde will be reduced. Furthermore, lower moulding pressures can be used and/or the cycle time can be reduced. The use of pistons to feed mouldable material into the moulding cavity may facilitate the use of recycled plastics materials such as PET.

1. Apparatus for manufacturing a preform which includes a mould comprising a female die member and a male die member in the form of an elongate core which together define between them a mould cavity having the shape of said preform, a barrel which communicates with said cavity, means for feeding mouldable material into said barrel, a piston, and means for advancing said piston along said barrel so that the front face thereof displaces said mouldable material out of said barrel and into said cavity, the front face of said piston, when said piston is fully advanced, becoming part of the bounding wall of said cavity.

2. Apparatus as claimed in claim 1, in which said barrel communicates with said cavity on the side thereof opposite to said core, said front face of said piston being of concave generally hemispherical form.

3. Apparatus as claimed in claim 1 in which said barrel is constituted by a passageway in said core and said front face is of convex generally hemispherical form.

4. Apparatus as claimed in claim 1, wherein said barrel is constituted by a cylindrical extension of said cavity and said front face is the annular front face of a tubular piston.

5. Apparatus as claimed in claim 3 and further including a blow moulding cavity and means for transferring the core with a moulded preform on it from said female die member to said blow moulding cavity.

6. Apparatus as claimed in claim 5, wherein said core includes first and second parts which can be displaced relatively to one another to increase and decrease the length of said core.

7. A method of manufacturing a preform which method includes the steps of closing a mould comprising a male member and a female member which together partly define a mould cavity that has the shape of said preform, feeding mouldable material into a barrel the bore of which communicates with said cavity, and advancing a piston along said barrel so that said piston urges said material out of said barrel and into said cavity, said piston having a concave front face which, in the fully advanced position of said piston, completes said mould cavity and constitutes that part of the bounding wall of said mould cavity which moulds the outer face of the dome-shaped end surface of said preform.

8. Apparatus for manufacturing a preform which apparatus comprises a mould comprising a male member and a female member which together partly define a mould cavity that has the shape of said preform, a barrel, means for feeding mouldable material into said barrel the bore of which communicates with said cavity, a piston and means for advancing said piston along said barrel so that said piston urges said material out of said barrel and into said cavity, said piston having a concave front face which, in the fully advanced position of said piston, completes said mould cavity and constitutes that part of the bounding wall of said cavity which moulds the outer face of the dome-shaped end surface of said preform.

9. A method of manufacturing a preform which method comprises closing a mould including a female member and a core constituting a male member which together define a mould cavity having the shape of said preform, feeding mouldable material into a cylindrical extension of said mould cavity which extension is bounded internally by said male member and externally by said female member; and advancing a tubular piston along said extension to force said material out of said extension and into said cavity, the annular leading face of said piston, once it is fully advanced, becoming part of the bounding wall of said mould cavity.

10. A method as claimed in claim 9 and including the step of withdrawing the moulded preform and said core from said female member, inserting said preform and core into a blow moulding cavity and feeding air along a passage in said core to expand said preform into said blow moulding cavity.

11. A method as claimed in claim 10 and including the further step of stretching the preform before blowing by extending said core.

12. Apparatus for manufacturing a preform which apparatus comprises a mould including a female member and a core constituting a male member which together define a mould cavity having the shape of said preform, means for feeding mouldable material into a cylindrical extension of said mould cavity which extension is bounded internally by said male member and externally by said female member; a tubular piston and means for advancing said piston along said extension to force said material out of said extension and into said cavity, the annular leading face of said piston, once it is fully advanced, becoming part of the bounding wall of said mould cavity.

13. A method of moulding a preform which method includes the steps of closing a mould comprising a female member and a core constituting a male member which together define a mould cavity having the shape of said preform, feeding mouldable material into a barrel constituted by a bore extending along said core which bore communicates with said cavity, and advancing a piston in said barrel so that the front face thereof forces said material out of said barrel and into said cavity, said front face being dome-shaped and, when said piston is fully advanced, becoming that part of the bounding wall of said mould cavity which defines the inner surface of the dome-shaped end of said preform.

14. A method as claimed in claim 13 and which further includes the step of withdrawing said preform and said core from said female member, inserting said preform and core into a blow moulding cavity and feeding air along a passage in said core to expand said preform into said blow moulding cavity.

15. A method as claimed in claim 14, and including the further step of stretching said preform before blowing by extending said core.

16. Apparatus for moulding a preform which apparatus includes a mould comprising a female member and a core constituting a male member which together define a mould cavity having the shape of said preform, a barrel, means for feeding mouldable material into said barrel, said barrel being constituted by a bore extending along said core and which communicates with said cavity, a piston in said barrel, and means for advancing said piston in said barrel so that the front face thereof forces said material out of said barrel and into said cavity, said front face of the piston being dome-shaped and, when said piston is fully advanced, becomes that part of the bounding wall of said mould cavity which defines the inner surface of the dome-shaped end of said preform.

17. A preform when manufactured by the method of claim 7.

18. A preform when manufactured by the apparatus of claim 1.

19. A preform from which a bottle can be blown, and which preform is of hollow cylindrical form, said preform being open at one end and closed at the other by a dome-shaped end wall, there being at the other end thereof external formations which form the means for attaching a closure to the bottle once blown, the dome-shaped external end surface of said preform being devoid of an injection point stress zone.
